(19) United States
(12) Patent Application Publication
(10) Pub. No.: US 2025/0053905 A1
(43) Pub. Date: Feb. 13, 2025

(54) COMPUTER-IMPLEMENTED METHOD FOR UNSUPERVISED TASK SEGMENTATION

(71) Applicant: NICE LTD., Ra'anana (IL)

(72) Inventors: Eran ROSEBERG, Hogla (IL); Oz GRANIT, Ramat-Gan (IL); Yuval SHACHAF, Tzur Moshe (IL)

(21) Appl. No.: 18/232,397

(22) Filed: Aug. 10, 2023

(51) Int. Cl. G06Q 10/0631; G06F 9/451; G06F 40/30

(52) U.S. Cl. CPC G06Q 10/06316; G06F 9/451; G06F 40/30

(57) ABSTRACT

A computer-implemented method for unsupervised task segmentation. The computer-implemented method includes receiving a stream of data of desktop-actions. Each desktop-action relates to UI data-handling operations of applications, and labeled with an action-related integer id, operating an unsupervised task segmentation module on the stream of data of desktop-actions to identify sequences of desktop-actions. The unsupervised task segmentation module includes creating an integer sequence from the action related integer id, such that desktop-actions are consecutively concatenated, creating word embeddings of the UI data-handling operations of applications for each desktop-action based on the integer id thereof, to yield a vector of embeddings, and implementing unsupervised topic-segmentation NLP module on the created vector of embeddings to determine cutting-points in the integer sequence to yield segments such that semantic-similarity-level of embeddings in each yielded segment is maximized, and a number of non-complete business processes is reduced. Each cutting-point indicates an end of a segment.

### TECHNICAL FIELD

The present disclosure generally relates to Robotic Process Automation (RPA) solutions, and more specifically to unsupervised task segmentation from an unsegmented User Interface (UI) actions log.

### BACKGROUND

One of the main building blocks of an automation process life-cycle is identifying business processes within an enterprise that are significant candidates for automation, namely, they are feasible for automation and may yield high potential Return on Investment (ROI) by saving significant manual efforts and workloads when handled by robots instead of human agents.

For that purpose of identifying business processes within an enterprise that are significant candidates for automation, a continuous recording of a workflow of routines, desktop-actions and screen elements to complete a business process, is operated. Then, the recorded workflow is forwarded to a tool that breaks the workflow to provide a set of automatically-discovered desktop-actions of the business process, which is User Interface (UI) data-handling operations of applications to achieve a task.

Currently, each task that includes data-handling operations of applications to achieve the task is extracted by the tool based on predefined rules that determine where each task ends, i.e., where in the workflow of UI data-handling operations of applications, a task ends such that the data-handling operations of applications represent desktop-actions of a business process for automation. Various techniques are employed, such as Hidden Markov Models (HMM) s and Conditional Random Fields to recognize emerging patterns in the data. Modern Robotic Process Automation (RPA) UI logs are very noisy, thus, labeling of the data is difficult. Therefore, there is a need for a technical solution that may use unsupervised methods in the field of desktop-actions identification.

Moreover, current rule-based approach of the RPA tool has several deficiencies. First, the identified sets of data-handling operations of applications to achieve a task may be difficult to justify in terms of profitability and automation ROI. Second, sets of data-handling operations of applications to achieve a task which may be more significant than the identified ones can be easily missed, and third the discovery process is biased, time-consuming and very expensive.

Accordingly, there is a need for a technical solution that will automatically identify the most significant business flows for automation in RPA.

Furthermore, there is a need for a technical solution that will use unsupervised task segmentation instead of currently used rule-based approach to break a stream of desktop-actions into sentences which represent tasks and thus greatly improving any previously achieved discovery results.

### SUMMARY

There is thus provided, in accordance with some embodiments of the present disclosure, a computerized-method for unsupervised task segmentation.

Furthermore, in accordance with some embodiments of the present disclosure, the computer-implemented method for unsupervised task segmentation may include receiving a stream of data of desktop-actions, where each desktop-action relates to User Interface (UI) data-handling operations of applications, and each desktop-action is labeled with an action related integer identification (id). Then, operating an unsupervised task segmentation module on the stream of data of desktop-actions to identify one or more sequences of desktop-actions, where each sequence of desktop-actions is identified as a sequence to achieve a task, and each task is a business process that is operated by a user and the business process is appropriate for automation.

Furthermore, in accordance with some embodiments of the present disclosure, the unsupervised task segmentation module may include creating an integer sequence from the action related integer id, such that desktop-actions in the stream of data are consecutively concatenated and then creating word embeddings of the UI data-handling operations of applications for each desktop-action based on the integer id thereof to yield a vector of embeddings. After the creating of the word embeddings, the unsupervised task segmentation may implement unsupervised topic-segmentation Natural Language Processing (NLP) module on the created vector embeddings to determine one or more cutting-points in the integer sequence to yield one or more segments, such that semantic similarity level of embeddings in each yielded segment is maximized, and a number of non-complete business processes is reduced.

Furthermore, in accordance with some embodiments of the present disclosure, the similarity level of desktop-actions in each yielded segment may be maximized by defining a target function. The target function is

$$J ( T ) := {\sum }_{i = 0}^{n - 1} ( ‖ {υ}_{i} ‖ - π ) .$$

whereby:

vi is a segment vector which is a sum of all vector embeddings in a segment [symbol] where w_i is a vector having one or more vector embeddings, and
π is a penalty for each segment to avoid a segment of one word due to the maximizing of the similarity level.

Furthermore, in accordance with some embodiments of the present disclosure, the UI data-handling operations of applications may be collected from computer-devices of users by a Real-Time (RT) client that is running on each user computer-device and sends user desktop-actions to an RT server to be combined and exported to the database.

Furthermore, in accordance with some embodiments of the present disclosure, the preprocessing of the data may further include removing UI data-handling operations that have been predetermined as insignificant.

Furthermore, in accordance with some embodiments of the present disclosure, the unsupervised task segmentation module may be pretrained to learn word embeddings, and each word is a desktop-action related to UI data-handling operations of applications.

Furthermore, in accordance with some embodiments of the present disclosure, the unsupervised task segmentation module may be pretrained to learn word embeddings by a Word2Vec algorithm.

Furthermore, in accordance with some embodiments of the present disclosure, bots may be created by the identified repetitive segments for automation being transformed into code. The code is a set of instructions and logic which is executed at runtime as a dynamic linked library interacting with one or more applications. The bots may replace human agents in the contact center in operating the automated business process.

### BRIEF DESCRIPTION OF THE DRA WINGS

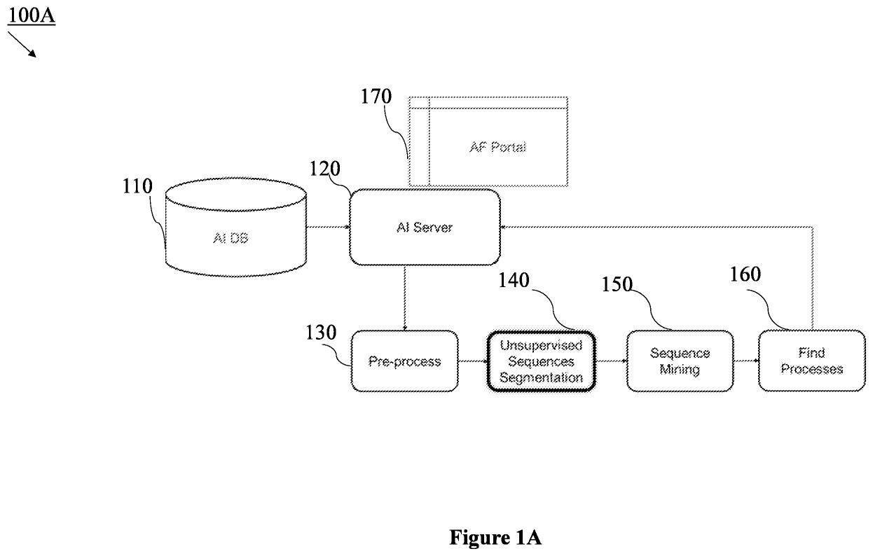

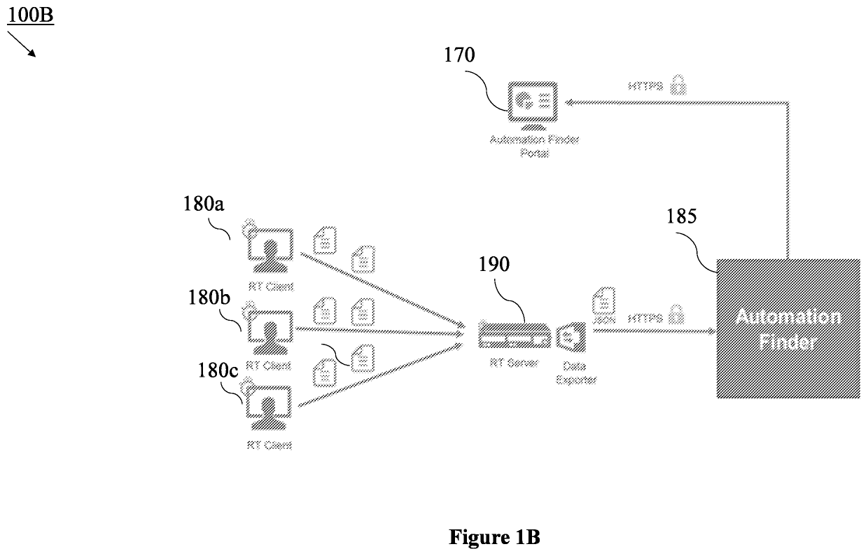

FIGS. 1A-1B schematically illustrate a high-level diagram of a system for finding routines for automation, in accordance with some embodiments of the present disclosure;

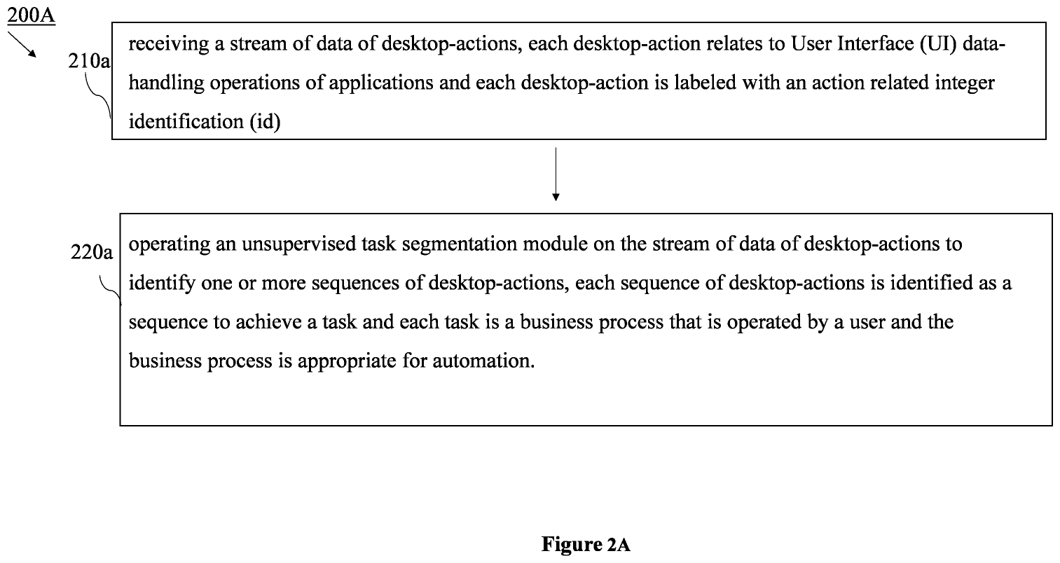

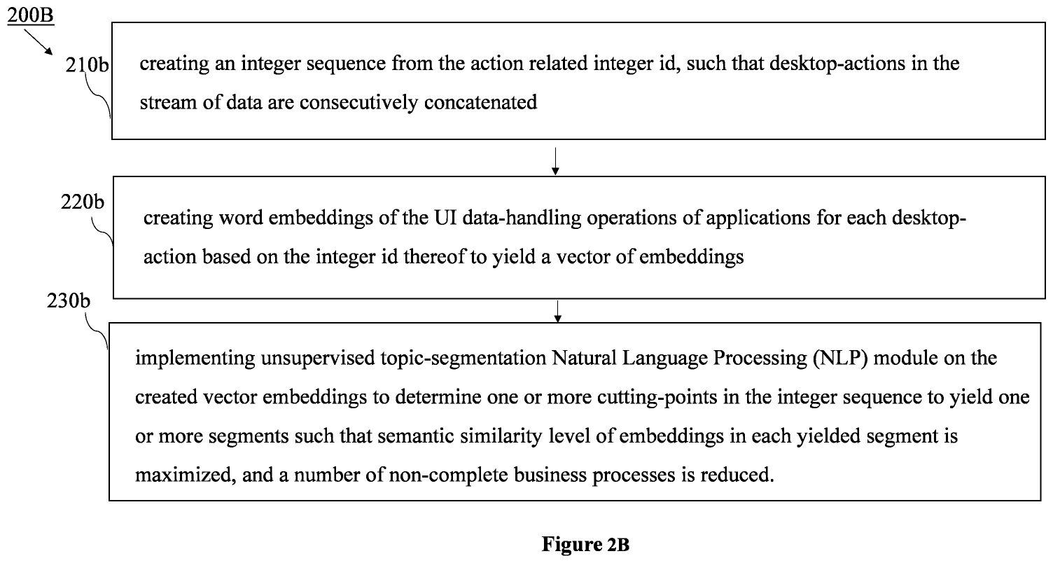

FIG. 2A is a high-level workflow of a computer-implemented method for unsupervised task segmentation, in accordance with some embodiments of the present disclosure;

FIG. 2B is a high-level workflow of an unsupervised task segmentation module, in accordance with some embodiments of the present disclosure;

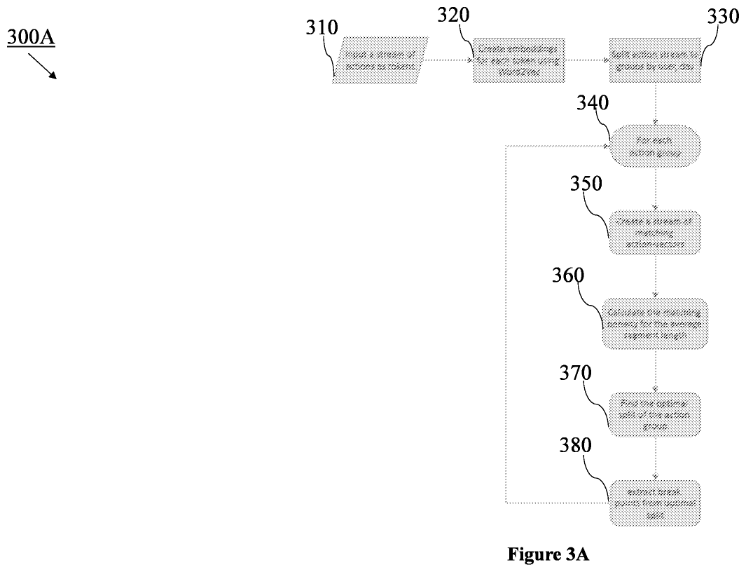

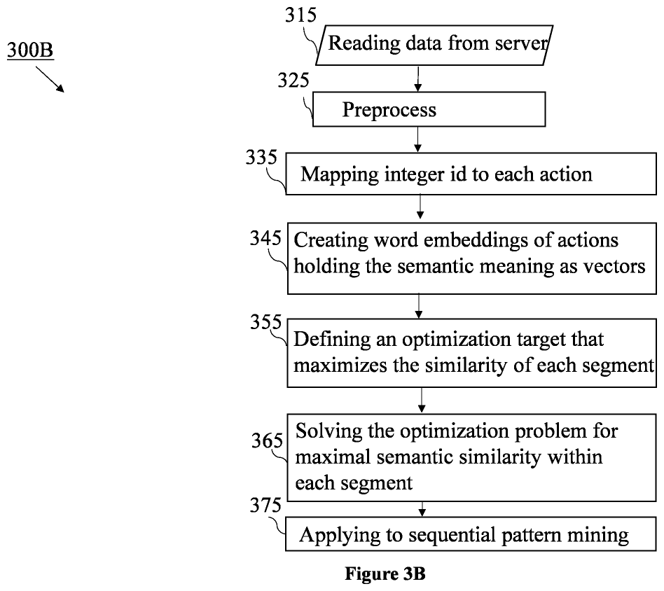

FIGS. 3A-3B are a high-level workflow of a computer-implemented method for unsupervised task segmentation, in accordance with some embodiments of the present disclosure;

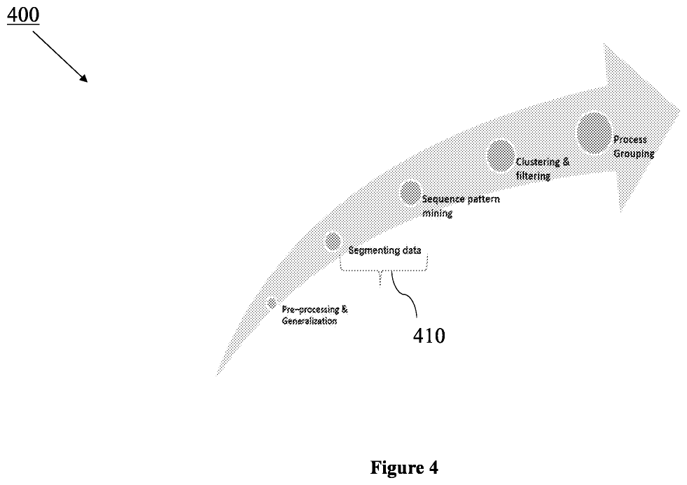

FIG. 4 is a diagram of Automatic Finder (AF) Machine Learning engine pipeline, in accordance with some embodiments of the present disclosure;

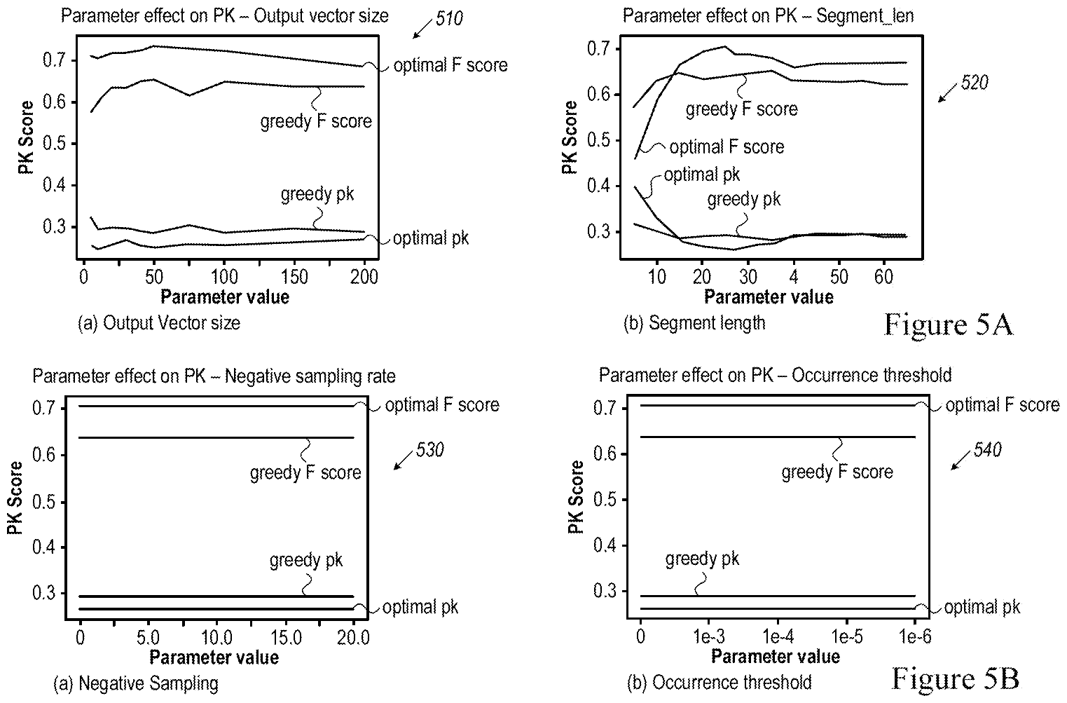

FIG. 5A shows results of simulations with effective parameters (Kyoto), in accordance with some embodiments of the present disclosure;

FIG. 5B shows results of simulations with ineffective parameters (Kyoto), in accordance with some embodiments of the present disclosure;

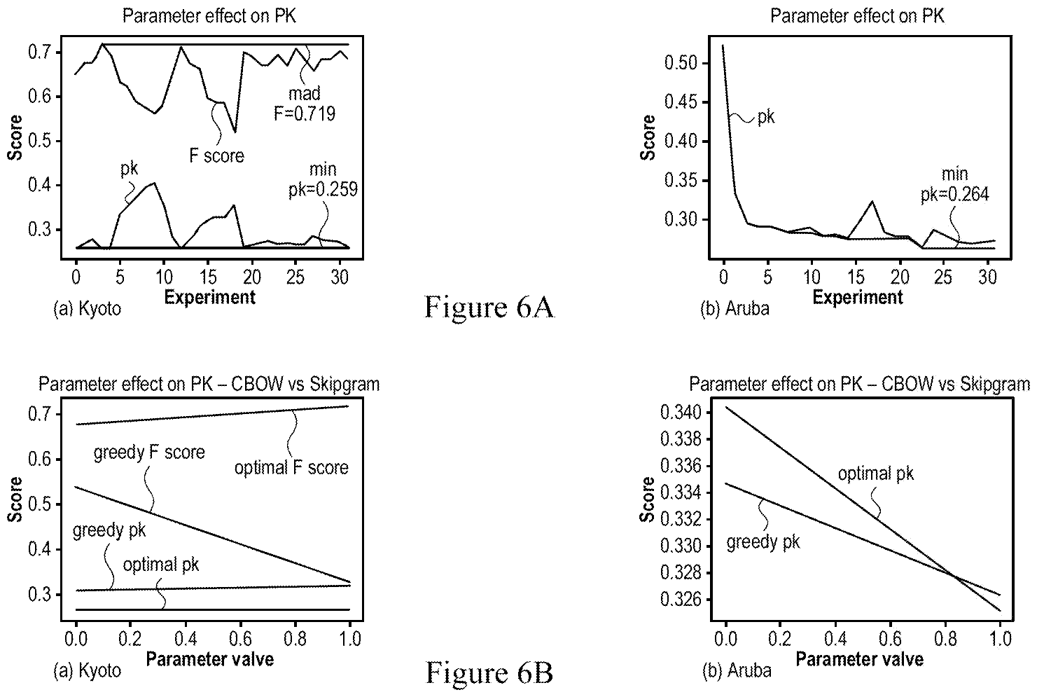

FIGS. 6A-6B show results of simulations with hyper-parameter tuning across Kyoto and Aruba datasets, in accordance with some embodiments of the present disclosure;

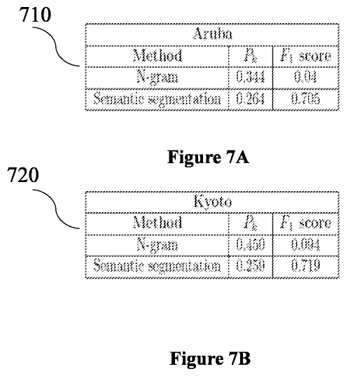

FIGS. 7A-7B show a comparison of results of computer-implemented method for unsupervised task segmentation to results of N-gram algorithm, in accordance with some embodiments of the present disclosure;

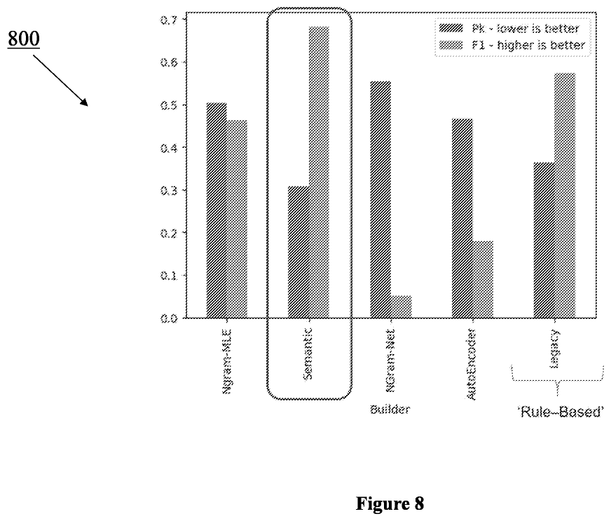

FIG. 8 shows a graph of comparison of results of computer-implemented method for unsupervised task segmentation to results to other solutions, in accordance with some embodiments of the present disclosure; and

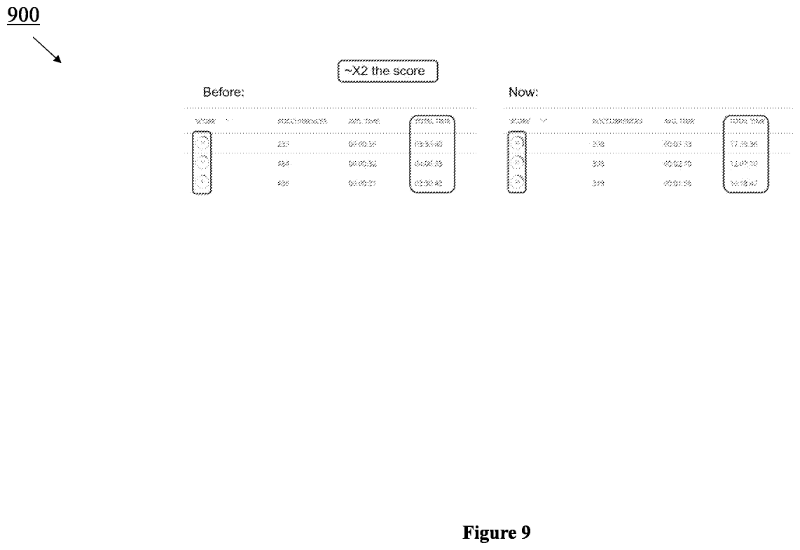

FIG. 9 shows a comparison of results of computer-implemented method for unsupervised task segmentation and previous solution, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Current process mining tools, such as, Celonis®, timelinePI®, ProcessGold®, Minit® and the like, attempt to identify potential automation of business processes based on system event logs by the process of gathering labeled data from log events of enterprise applications. However, this process of gathering the labeled data from the log events is a lengthy process, which requires customer cooperation, and not all existing applications generate such logs. Moreover, the analysis of current process mining tools is on the level of step-in-business-process but doesn't consider the actual desktop-actions which are included in a business process, i.e., to complete a specific step in a process.

Current process mining tools present the organization with a complete end-to-end flow and identified potential bottlenecks. However, they have several disadvantages, such as, a lengthy process of data gathering, lack of complete data, and disconnection between steps in a flow to what can be automated by a Robotic Process Automation (RPA) for each step of the flow and the lack of information in advance in which business process there are issues that should be analyzed.

Some process mining vendors have added ‘Task Mining’ capabilities which enrich the process mining data with desktop-action data, however it is only valuable in the context of the business process which was previously analyzed with event logs of the applications and not an independent automation discovery capability.

There are open-source tools for process mining, such as ProM® and it is technically a solved problem when there are event logs. The different solutions in this area are different by the data presentation options, ease of data gathering, ease of use, and monitoring capabilities.

An automation finder tool, on the other hand, doesn't use applications generated labeled data from applications logs, but instead collects the data from employee desktop-actions. Accordingly, there is a need for a technical solution that will be based on collected desk-top actions and analyzed by unsupervised Machine Learning (ML) models to provide information which business process should be automated. Therefore, there is a need for a computer-implemented method for unsupervised task segmentation.

FIG. 1A schematically illustrates a high-level diagram of a system 100A for finding routines for automation, in accordance with some embodiments of the present disclosure.

According to some embodiments of the present disclosure, an Artificial Intelligence (AI) server 120 may perform the following phases to generate a report of routines, e.g., business processes that should be analyzed and display the routines via an Automation Finder (AF) portal 170. Instead of displaying the routines, the routines may be transformed into code which may be executed at runtime as a bot instead of having a human agent for the business process.

According to some embodiments of the present disclosure, a system, such as system 100A for finding routines for automations may include a database, such as AI database 110 to store all low-level desktop-actions collected from all users. The data may include, for example timestamp, type, process names, window title, and other keys status, such as Ctrl, Alt.

According to some embodiments of the present disclosure, the system 100A may further include a preprocess model 130 to clean i.e., dropping insignificant desktop-actions, enriching i.e., create addition meta-data, and normalizing the collected data, such as for example, replacing dates with the word “datetime”.

The system 100A may further include a model that segments a stream of desktop-actions by determining where each task ends in a stream of desktop-actions. Commonly, the segment is bounded by time, of actions that form a sequence of user actions. The data-handling operations of applications to achieve the task may be extracted by a tool that is based on predefined rules. The predefined rules determine where each task ends, i.e., where in the workflow of UI data-handling operations of applications, a task ends, such that the data-handling operations of applications, represent desktop-actions of a business process for automation.

According to some embodiments of the present disclosure, the model that segments the stream of desktop-actions may be operated by an unsupervised sequences segmentation 140 model, which may operate a computer-implemented method for unsupervised task segmentation, such as computer-implemented method 200A for unsupervised task segmentation, in FIG. 2A which may operate an unsupervised task segmentation module, such as unsupervised task segmentation module 200B in FIG. 2B.

According to some embodiments of the present disclosure, a routine mining module, such as sequence mining 150 may operate a sequential pattern mining, to find repetitive sequences in a given data that contains a set of segments, which are related as sentences. The implementation of the pattern mining may be by any mining technique, such as legacy PrefixSpan® or may be graph-based, e.g., Markov graph. A find processes 160 may be operated by grouping previously found segments, e.g., sequences of desktop-actions into processes, such that each process may describe a business process.

According to some embodiments of the present disclosure, after the collected desktop-actions are preprocessed by the preprocess model 130, the sequential desktop-actions are labeled with an action related integer identification (id) per action type and each desktop-action relates to User Interface (UI) data-handling operations of applications, e.g., action type. This integer id is given by the preprocessing model 130. All the actions from all users are concatenated to a long integer sequence, such that users' actions are consecutive.

According to some embodiments of the present disclosure, the unsupervised sequences segmentation 140 may be implemented by a computer-implemented method 200A for unsupervised task segmentation, in FIG. 2A which may be based on an approach similar to the approach developed by Alemi and Ginsparg in “Text segmentation based on semantic word embeddings”.

According to some embodiments of the present disclosure, each desktop-action in the stream of data of desktop-actions may be related to as a word and a sequence of desktop-actions may be related to as a sequence of words. The unsupervised sequences segmentation 140 may break a stream of data of desktop-actions, e.g., a sequence of words into coherent segments, e.g., one or more sequences of desktop-actions, where each sequence of desktop-actions is identified as a sequence to achieve a task, and each task is a business process that is operated by a user and the business process is appropriate for automation.

According to some embodiments of the present disclosure, the words, i.e., desktop-actions May be represented by word vectors. The segments may be related as sequences of words, and the vectorization of a segment may be formed by summing the vectorizations of the words. Suppose V is a segment given by the word sequence (W₁, . . . . Wₙ) and let wᵢ be the word vector of Wᵢ and ν=Σᵢwᵢ the segment vector of V.

According to some embodiments of the present disclosure, ∥ν∥ may be interpreted as a weighted sum of cosine similarities as follows:

$$‖ υ ‖ = 〈 υ , \frac{υ}{‖ υ ‖} 〉 = {\sum }_{i} 〈 {w}_{i} , \frac{υ}{‖ υ ‖} 〉 = \vert {\sum }_{i} ‖ {w}_{i} ‖ 〈 \frac{{w}_{i}}{‖ {w}_{i} ‖} , \frac{υ}{‖ υ ‖} 〉$$

As word embeddings are commonly compared with cosine similarity, the last scalar product, i.e.,

$$\text{?}$$

$$\text{?} \text{indicates text missing or illegible when filed}$$

is the similarity of a word wᵢ to the segment vector V.

According to some embodiments of the present disclosure, the weighting coefficient ∥wᵢ∥ suppress frequent noise words, which are user actions which are not significant to complete the task, such as mouse clicks on the desktop. These noise words are small vector norms of the embedding as they appear in many contexts and their embeddings tend to be close to many other words which are unrelated to each other. ∥ν∥ may be related as an accumulated weighted cosine similarity of the word vectors of a segment to the segment vector. In other words, the more similar the word vectors are to the segment vector, the more coherent the segment is.

According to some embodiments of the present disclosure, a stream of data of desktop-actions of length L may be segmented into coherent segments with word boundaries given by the segmentation:

T=(t₀, . . . ,tₙ) such that 0=t₀<t₁<tₙ=L

When maximizing the sum of segment vector lengths, by T maximising:

$$J ( T ) = {\sum }_{i = 0}^{n - 1} ‖ {v}_{i} ‖$$

then, without further constraints, the optimal solution to J is the partition splitting the data completely, so that each segment is a single word, shown from the triangle inequality.

According to some embodiments of the present disclosure, to avoid the splitting of the stream of desktop-actions into each segment having a single word, which practically means a business process with one desktop-action for automation, a limit must be imposed on the granularity of the segmentation. For that purpose, a penalty may be imposed for every split made, by subtracting a fixed positive number π for each segment.

According to some embodiments of the present disclosure, the error function may be operated by formula I:

$$J ( T ) = {\sum }_{i = 0}^{n - 1} ( ‖ {v}_{i} ‖ - π )$$

which may be solved by using the greedy approach or the Dynamic Programming (DP) approach.

According to some embodiments of the present disclosure, the greedy approach tries to maximize J(T) by choosing split positions one at a time. The greedy algorithm works as follows: split the text iteratively at the position where the score of the resulting segmentation is highest, until the gain of the latest split drops below the given penalty threshold.

According to some embodiments of the present disclosure, the splits resulting from the greedy approach may gain less than the penalty π thus lowering the score. Therefore, segmentation based on the greedy approach may be suboptimal.

According to some embodiments of the present disclosure, the Dynamic Programming (DP) approach exploits the fact that the optimal segmentation of all prefixes of a sequence up to a certain length can be extended to an optimal segmentation of the whole. The DP is using intermediate results to complete a partial solution. Let T=(t₀, t₁, . . . , tₙ) be the optimal segmentation of the whole document, then, T′=(t₀, t₁, . . . , tₖ) is optimal for the document prefix up to word Wₖ. If this is not so, then the optimal segmentation for the document prefix (t₀, t₁, . . . , tₖ) would extend to a segmentation T″ for the whole document, using tₖ₊₁, . . . , tₙ with J(T″)<J(T), contradicting optimality of T. It provides a constructive induction given optimal segmentations {T\hat{ }i|0<i<k, ≠T\hat{ }i optimal for first i words}, the optimal segmentation T^{k} may be constructed up to word k, by trying to extend any of the segmentations Tⁱ, ˜0<i<k by the segment (Wᵢ, . . . . Wₖ), then choosing i to maximise the objective. The reason it is possible to divide the maximization task into parts is the additive composition of the objective and the fact that the norm obeys the triangle inequality.

According to some embodiments of the present disclosure, the run-time of this approach is quadratic in the input length, which may be an issue when the sequences are long. However, by introducing a constant that specifies the maximal segment length, the complexity may be reduced to merely linear.

According to some embodiments of the present disclosure, both the greedy algorithm and the DP approach depend on the penalty hyper-parameter n, which controls segmentation granularity, the smaller it is, the more segments may be created.

According to some embodiments of the present disclosure, the penalty hyper-parameter π, may be determined by choosing a desired average segment length m. Given a sample of documents, record the lowest gains returned when splitting each document iteratively into as many segments as expected on average due to m, according to the greedy method and then taking the mean of these records as n.

According to some embodiments of the present disclosure, the implementation of the greedy algorithm may be used to require a specific number of splits and retrieve the gains. In experimentation, the penalty hyper-parameter π may be adjusted through changes to the average segment length m.

$$J ( T ) := \text{?} ,$$

$$where$$

$$\text{?} := \text{?} + … + \text{?}$$

$$\text{?} \text{indicates text missing or illegible when filed}$$

With penalty:

$$J ( T ) := {\sum }_{i = 0}^{n - 1} ( ‖ {υ}_{i} ‖ - π ) .$$

According to some embodiments of the present disclosure, the segments yielded from the unsupervised sequence segmentation 140 which has been operated on the stream of data of desktop-actions, may be forwarded to a sequence mining 150 and then sequences may be forwarded to identify new possible routines-types which are potential business process automations 160.

According to some embodiments of the present disclosure, the automations are composed of actions, translated from the automation finder tool, as a set of corresponding objects inside the automation tool, for example, objects, such as, workflow steps functions and screen elements. These representations e.g., objects, such as workflow steps functions and screen elements, are then transformed into code, which is a set of instructions and logic that a robot e.g., an agent bot may then execute at runtime as a dynamically linked library interacting with various applications within the enterprise instead of a human agent performing the User Interface (UI) data-handling operations of the applications.

According to some embodiments of the present disclosure, an instruction may be submitted to one or more remote computers based on one or more of the automation routines from find processes 160, to automatically execute at least one computer operation on one or more of the remote computers. Then, automation routines and/or action sequences, as well as individual computer operations may be automatically executed on a remote computer, or by a plurality of remote computers, based on an instruction sent or transmitted by embodiments of the invention. For example, based on the example action sequence provided below, embodiments may produce or provide an automation data item formatted as a table or as a JavaScript Object Notation (JSON) object, such as, e.g., the automation routine composed of the following list of operations.

According to some embodiments of the present disclosure, the example action sequence may be:
1. Copying data of textBoxContactStreet, textBoxContactCity, comboBoxContactState, textBoxContactZip, textBoxContactFirstName, textBoxContactLastName, textBoxContactEmail and textBoxContactPhone on screen “Training CRM—Contacts”.
2. Pasting data into Street, City, State/Province and Postal Code on screen “Timothy Mercado Properties”.
3. Clicking on New Tab on screen “Get in touch|NICE—Google Chrome34”.
4. Clicking on Data Collection on screen “Customers—Week*—December—All Documents35”.
5. Pasting data into INPUT on screen “Contact Book” and Typing text in INPUT on screen “Contact Book”.

According to some embodiments of the present disclosure, the identified new possible routines-types that have been found during the mining process 150, following the sentence segmentation 140, may be selected automatically, either based on score or any other metric for automation. The selected routines-types, represented by a JSON object may be automatically sent to an automation platform where it is converted to actual set of windows action to be executed by the bot.

FIG. 1B schematically illustrate a high-level diagram of a system 100B for finding routines for automation, in accordance with some embodiments of the present disclosure.

According to some embodiments of the present disclosure, a Real Time client, such as RT client 180a-180c may collect all user's desktop-actions and store all the low-level desktop-actions collected from all users in a database, such as AI database 110 in FIG. 1A, which may be associated with an RT server 190. The collected data may include, for example desktop-actions which may be generated by any Windows user such as timestamp, type, process names, window title, and other keys status, such as Ctrl, Alt. The RT server 190 may combine those desktop-actions and export them for example, such as JSON files via Hypertext Transfer Protocol Secure (HTTPS) connection to the Automation Finder 185 and such as find processes 160 in FIG. 1A.

According to some embodiments of the present disclosure, the Automation Finder (AF) 185 may identify automation opportunities of business processes, by discovering repetitive sequences. The AF 185 may be based on unique desktop analytics and machine-learning capabilities. Based on the collected data, the AF 185 may identify sets of sequences with automation potential, display aggregated data per identified sequence, display a list of instances per sequence and present findings as a set of sequences with automation potential with an automation finder portal 170, such as AF portal 170 in FIG. 1A.

According to some embodiments of the present disclosure, the data, stored in a database, such as AI database 110 in FIG. 1A may store tables and data structures of user desktop events e.g., desktop-actions which that are accessible by an automation finder engine, The automation finder engine may preprocess the user's desktop-actions e.g., by pre-process 130 in FIG. 1A and then may forward to a segmentation module, such as unsupervised sequences segmentation 140 in FIG. 1A to split the user's desktop-actions into sentences, which is less likely to miss routine-type for automation and may not be biased and time-consuming, as a segmentation module that is implementing a rule-based approach.

According to some embodiments of the present disclosure, the segments, may be yielded by implementing an unsupervised topic-segmentation Natural Language Processing (NLP) module on a created vector of embeddings of the UI data-handling operations of applications for each desktop-action based on the integer id thereof. The NLP module may determine one or more cutting-points in the integer sequence, such that semantic similarity level of embeddings in each yielded segment is maximized, and a number of non-complete business processes is reduced. The segments may be related as sentences of desktop-actions.

According to some embodiments of the present disclosure, these sentences of user actions may be a combination of several desktop-actions that express a particular business function or routine type. By using these sentences, repetitive sequences may be identified, for example, by sequence mining 150 in FIG. 1A, which may be sequences that have corresponding user desktop-actions that are consecutive and/or within the same time frame and are repeated within a stream of user desktop-actions. The identified repetitive sequences may be filtered, for example, by find processes 160 in FIG. 1A to identify sequences that have the highest Return On Investment (ROI). Once significant sequences are identified and named, those may be used to build one or more desktop automation.

FIG. 2A is a high-level workflow of a computer-implemented method 200A for unsupervised task segmentation, in accordance with some embodiments of the present disclosure.

According to some embodiments of the present disclosure, operation 210a comprising receiving a stream of data of desktop-actions, each desktop-action relates to User Interface (UI) data-handling operations of applications and each desktop-action is labeled with an action related integer identification (id).

According to some embodiments of the present disclosure, operation 220a comprising operating an unsupervised task segmentation module on the stream of data of desktop-actions to identify one or more sequences of desktop-actions, each sequence of desktop-actions is identified as a sequence to achieve a task and each task is a business process that is operated by a user and the business process is appropriate for automation.

According to some embodiments of the present disclosure, computer-implemented method 200A for unsupervised task segmentation improves text segmentation techniques.

FIG. 2B is a high-level workflow of an unsupervised task segmentation module 200B, in accordance with some embodiments of the present disclosure.

According to some embodiments of the present disclosure, operation 210b comprising creating an integer sequence from the action related integer id, such that desktop-actions in the stream of data are consecutively concatenated.

According to some embodiments of the present disclosure, operation 220b comprising creating word embeddings of the UI data-handling operations of applications for each desktop-action based on the integer id thereof to yield a vector of embeddings.

According to some embodiments of the present disclosure, operation 230b comprising implementing unsupervised topic-segmentation Natural Language Processing (NLP) module on the created vector of embeddings to determine one or more cutting-points in the integer sequence to yield one or more segments such that semantic similarity level of embeddings in each yielded segment is maximized, and a number of non-complete business processes is reduced.

According to some embodiments of the present disclosure, each cutting-point of the one or more cutting-points in the integer sequence indicates an end of a first segment and a beginning of a second consecutive segment, and the one or more segments which represent complete tasks are provided to a routine mining module to identify repetitive segments for automation thereof.

FIG. 3A is a high-level workflow of a computer-implemented method 300A for unsupervised task segmentation, in accordance with some embodiments of the present disclosure.

According to some embodiments of the present disclosure, in a system, such as system 100A in FIG. 1A which may operate a computer-implemented method for unsupervised task segmentation, such as computer-implemented method 200A for unsupervised task segmentation, in FIG. 2A which may operate an unsupervised task segmentation module, such as unsupervised task segmentation module 200B in FIG. 2B, an input of a stream of actions may be received as tokens 310. The stream of actions may be data of desktop-actions, where each desktop-action relates to User Interface (UI) data-handling operations of applications, and each desktop-action is labeled with an action related integer identification (id).

According to some embodiments of the present disclosure, creating an integer sequence from the action related integer id, such that desktop-actions in the stream of data are consecutively concatenated, and then creating word embeddings of the UI data-handling operations of applications for each desktop-action based on the integer id thereof to yield a vector of embeddings, for example, by creating embeddings for each token using Word2Vec 320.

According to some embodiments of the present disclosure, splitting the action stream to groups by user and day 330 and for each action group 340 creating a stream of matching action-vectors 350, for example by implementing unsupervised topic-segmentation Natural Language Processing (NLP) module on the created vector of embeddings to determine one or more cutting-points in the integer sequence to yield one or more segments, such that semantic similarity level of embeddings in each yielded segment is maximized, and a number of non-complete business processes is reduced.

According to some embodiments of the present disclosure, the semantic similarity level of embeddings in each yielded segment may be maximized by using the greedy approach or the Dynamic Programming (DP) approach. The greedy approach tries to maximize J(T) by choosing split positions one at a time and the DP approach exploits the fact that the optimal segmentation of all prefixes of a sequence up to a certain length can be extended to an optimal segmentation of the whole. Both the greedy algorithm and the DP approach depend on a penalty hyper-parameter π, which controls segmentation granularity, the smaller it is, the more segments may be created.

According to some embodiments of the present disclosure, the determining of the one or more cutting-points in the integer sequence may be include calculating the matching penalty hyper-parameter n for the average segment length 360 and finding the optimal split of the action group 370 to extract break points from optimal split 380.

FIG. 3B is a high-level workflow of a computer-implemented method 300B for unsupervised task segmentation, in accordance with some embodiments of the present disclosure.

According to some embodiments of the present disclosure, in a system, such as system 100A in FIG. 1A which may operate a computer-implemented method for unsupervised task segmentation, such as computer-implemented method 200A for unsupervised task segmentation, in FIG. 2A which may operate an unsupervised task segmentation module, such as unsupervised task segmentation module 200B in FIG. 2B, read data from server 315. The data may be data of desktop-actions, where each desktop-action relates to User Interface (UI) data-handling operations of applications, and each desktop-action is labeled with an action related integer identification (id). The desktop-actions have been generated by any Windows user such as timestamp, type, process names, window title, and other keys status, such as Ctrl, Alt. The server may be for example, AI server 120 in FIG. 1A.

According to some embodiments of the present disclosure, the data may be forwarded to preprocess 325, e.g., pre-process 130 in FIG. 1A.

According to some embodiments of the present disclosure, the preprocessing of the data may include mapping integer id to each action 335.

According to some embodiments of the present disclosure, operating a model, such as unsupervised sequences segmentation 140 in FIG. 1A on the stream of data of desktop-actions to identify one or more sequences of desktop-actions. The model may operate a computer-implemented method for unsupervised task segmentation, such as computer-implemented method 200A for unsupervised task segmentation, in FIG. 2A which may operate an unsupervised task segmentation module, such as unsupervised task segmentation module 200B in FIG. 2B.

According to some embodiments of the present disclosure, unsupervised task segmentation module may create word embeddings of actions holding the semantic meaning as vectors 345. Word vectors including Mikolov's Word2Vec, may be implemented to solve analogy tasks, machine translation, and sentiment analysis. The word vector approaches attempt to learn a log-linear model for word-word co-occurrence statistics. These word-word co-occurrence statistics encoding meaningful semantic and syntactic relationships may be relied on. Each desktop-action is related as a word in a new language.

According to some embodiments of the present disclosure, defining an optimization target that maximizes the similarity of each segment 355, e.g., each sentence and solving the optimization problem for maximal semantic similarity within each segment 365. The semantic similarity level of embeddings in each segment may be maximized by using the greedy approach or the Dynamic Programming (DP) approach.

According to some embodiments of the present disclosure, applying the sequential pattern mining 375, after sequence mining 150 in FIG. 1A and then find processes 160 in FIG. 1A. Robotic Process Automation (RPA) allows organizations to improve their processes by automating repetitive sequences of interactions between a user and one or more software applications e.g., routines. Thus, automating data entry, data transfer, and verification tasks, particularly when such tasks involve multiple applications. For the automation, these routines, e.g., repetitive sequences of interactions between a user and one or more software applications e.g., routines which are segments of desktop-actions, should be identified and determined as prone to automation.

According to some embodiments of the present disclosure, these repetitive sequences of interactions between a user and one or more software applications may be scattered across the process landscape which makes it difficult to find via interviews or manual observation of workers. The manual routine identification may be enhanced via automated methods, for example, methods that extract frequent patterns from these User Interaction (UI) logs of working sessions of one or more workers, which may be stored in a database, such as AI database 110.

According to some embodiments of the present disclosure, a UI log is a record of the interactions between one or more workers and one or more software applications. The recorded data is represented as a sequence of user interactions which are UI data-handling operations of applications, may be for example, selecting a cell in a spreadsheet or editing a text field in a form.

According to some embodiments of the present disclosure, the UI log may be filtered e.g., by a model such as preprocess model 130 in FIG. 1A to remove irrelevant UIs, e.g., mis-clicks. The event log consists of a set of traces of a task that is presupposed to contain one or more routines.

According to some embodiments of the present disclosure, a recording of a working session consists of a single sequence of actions encompassing many instances of one or more routines, interspersed with other events that may not be part of any routine. Traditional approaches to sequential pattern mining, particularly those that are resilient to noise i.e., irrelevant events, are not applicable to such unsegmented UI logs. Therefore, the UI log should be segmented, for an identification of candidate routines for automation by discovering frequent sequential patterns from a collection of sequences.

According to some embodiments of the present disclosure, once the UI log is segmented, e.g., by unsupervised segmentation 140 in FIG. 1A, sequential pattern mining techniques may be used to discover candidate routines.

According to some embodiments of the present disclosure, a text topic segmentation algorithm, such as unsupervised topic-segmentation Natural Language Processing (NLP) module may use semantic word embedding and Dynamic Programming (DP) for context segmentation of user desktop-actions, evaluated on open-source User Interface (UI) logs, separating a UI log to sub-sequences by routines. partly by redefining the set of user desktop-actions as a vocabulary.

According to some embodiments of the present disclosure, RPA allows organizations to automate intensive repetitive tasks i.e., routines. RPA tools capture in User Interface (UI) logs the execution of the routines. For each user a dataset is often a long sequence of desktop-actions, e.g., loginMail, accessMail, clickLink, acceptRequest. These sequences of desktop-actions may be then analyzed, to identify common patterns for automation.

According to some embodiments of the present disclosure, unlike the unsupervised topic-segmentation Natural Language Processing (NLP) module, supervised models require a predefined list of tasks and rely on short sequences containing a single routine. However, RPA UI logs are very noisy, and it is difficult to label the data.

According to some embodiments of the present disclosure, the unsupervised sequences segmentation 140 in FIG. 1A may segment a long sequence of words into non-overlapping coherent segments by implementing unsupervised topic-segmentation Natural Language Processing (NLP) module on a created vector of embeddings to determine one or more cutting-points in the integer sequence, such that semantic similarity level of embeddings in each segment is maximized, and a number of non-complete business processes is reduced.

FIG. 4 is a diagram of Automatic Finder (AF) Machine Learning engine pipeline, in accordance with some embodiments of the present disclosure.

According to some embodiments of the present disclosure, in a system, such as system 100A in FIG. 1A, after preprocessing and generalization of data of desktop-actions by a preprocessing model 130 in FIG. 1A, segmenting data 410 by a computer-implemented method for unsupervised task segmentation, such as computer-implemented method 200A for unsupervised task segmentation, in FIG. 2A which may operate an unsupervised task segmentation module, such as unsupervised task segmentation module 200B in FIG. 2B.

According to some embodiments of the present disclosure, the one or more segments may be forwarded to a sequence pattern mining, such as sequence mining 150 in FIG. 1A and then clustering and grouping the segments for process grouping.

According to some embodiments of the present disclosure, sequence segmentation of the data of desktop-actions may be operated by an unsupervised text segmentation technique, e.g., unsupervised topic-segmentation Natural Language Processing (NLP) module which may use semantic word embedding. For example, first to the UI log of the Centre for Advanced Studies in Adaptive Systems (CASAS) open-source activity recognition dataset, containing two subsets, Aruba and Kyoto, as shown in FIGS. 5A-5B and 6A-6B and then to tagged Automation Finder data (TSA) data, which is tagged data created for the Automatic Finder for demos and testing.

FIGS. 5A-5B show results of simulations with effective parameters (Kyoto), in accordance with some embodiments of the present disclosure.

According to some embodiments of the present disclosure, graphs 510-540 describe the performance of the model, using the Pₖ score and the F-score, as a variable of a hyperparameter using both algorithms, the greedy and Dynamic Programming (DP) on the Kyoto open source data-set. Graph 510 shows embedding vector size. Graph 520 shows average segment length which dictates the penalty n. Graph 530 shows negative sampling rate. Graph 540 shows occurrence threshold. The graphs 510-540 describe the tunning of the hyperparameters on the trained data.

According to some embodiments of the present disclosure, a computer-implemented method for unsupervised task segmentation, such as computer-implemented method 200A for unsupervised task segmentation, in FIG. 2A which may operate an unsupervised task segmentation module, such as unsupervised task segmentation module 200B in FIG. 2B has been evaluated on dataset of open real-life routines recorded in homes, to simulate UI logs in terms of its ability to rediscover routines contained in a log and in terms of scalability.

According to some embodiments of the present disclosure, Pₖ is a well-established metric for text segmentation, it describes the probability that a randomly chosen pair of words k words apart is inconsistently classified. Based on the article “Segmentation based on Semantic Word Embeddings”, Alexander A Alemi, Paul Ginsparg, published at 2015. The two approaches, the Greedy approach and DP approach, may be evaluated on documents composed of randomly concatenated document chunks, to check if the synthetic borders are detected. To measure the accuracy of a segmentation algorithm, the Pₖ metric may be used as follows.

According to some embodiments of the present disclosure, given any positive integer k, define pₖ to be the probability that a text slice S of length k, chosen uniformly at random from the test document, occurs both in the i^{th} segment of the reference segmentation and in the i^{th} segment the segmentation created by the algorithm, for some i, and set Pₖ=1-pₖ. For a successful segmentation algorithm, the randomly chosen slice S will often occur in the same ordinal segment of the reference and computed segmentation. In this case, the value of pₖ will be high, hence the value of Pₖ low. Thus, Pₖ is an error metric. k has been chosen to be one half the length of the reference segment.

According to some embodiments of the present disclosure, F₁ score is a common measure used to evaluate Machine Learning clustering algorithms. In order to calculate the F₁ score one first has to calculate precision and recall. For clustering algorithms, these metrics are defined between each pair of data points, if they are clustered together both in prediction and in label, this is considered a true positive classification. This evaluation metric has been chosen due to its use in unsupervised activity recognition. Due to the issue that this metric is quadratic in nature, and the length of target sequence, it proved to be impossible to compute in a straightforward way.

According to some embodiments of the present disclosure, to address this issue, the following assumptions are implemented. First, for most possible word pairs in a sequence of desktop-actions, the label is negative. This is due to the fact that the target segment length is much smaller than the total sequence length. Second, the target metric is F₁=2TP/(2TP+FP+FN) and does not require a calculation of True/Negative rate. These two assumptions combined may allow to reduce the number of points computed to O(NMK) where N denotes the full sequence length, M denotes the longest segment, true or predicted, and K denotes the largest number of segments, true or predicted.

According to some embodiments of the present disclosure, to perform this computation the sequence has been divided into 20 chunks, the number of chucks decided by the largest a library for the Python programming language, NumPy array fitting in memory. Each chunk of the sequence was used to calculate the TP, FP, FN. Ensuring each chunk was larger that the longest segment allowed us to make sure all errors were contained in the pairs missed when a segment was cut in the middle due to the chunking process. These pairs were accounted for and calculated separately.

According to some embodiments of the present disclosure, as to the parameter fine tuning, the performance strongly depends on the quality of both contextual word embedding and on the segmentation algorithm e.g., unsupervised topic-segmentation Natural Language Processing (NLP) module. In order to achieve the optimal performance, a grid search has been performed in order to optimize the models parameters. Pₖ has been used to evaluate each set of parameters, minimizing this metric.

According to some embodiments of the present disclosure, the parameters considered for word embedding such as Word2Vec were: negative sampling rate which controls how many “noisy words” should be drawn out, occurrence threshold which controls the occurrence threshold for words, causing highly occurring words in the text to be down-sampled, window size which controls the size of context window considered for each word by Word2Vec and output vector size which controls the size of output feature vector.

According to some embodiments of the present disclosure, the parameters considered for the segmentation algorithm were segment length which controls the penalty for segments having that length on average and Segment limit which controls the maximum segment length allowed for the dynamic programming algorithm. This parameter wasn't fine-tuned, as long as it is large enough it only controls run-time which did not pose an issue.

According to some embodiments of the present disclosure, after finding the optimal combination of parameters, each parameter has been isolated to examine its influence on the algorithms performance, both in terms of Pₖ and F₁ scores.

According to some embodiments of the present disclosure, using a negative sampling rate and occurrence threshold to improve the models performance.

According to some embodiments of the present disclosure, the output vector size and the segment length had the most dramatic effects on performance. This indicates both the semantic aspect of the vectors and the sensitivity in which clustering them created a great effect. Segment length also gives the best performance around the true mean partition length.

FIGS. 6A-6B show results of simulations with hyper-parameter tuning across Kyoto and Aruba datasets, in accordance with some embodiments of the present disclosure.

According to some embodiments of the present disclosure, experiments have been performed with the Skip-gram/Continuous Bag of Words (CBOW) models implementations of word2vec. Parameter fine-tuning was performed on the Centre for Advanced Studies in Adaptive Systems (CASAS) open-source dataset, using the Kyoto and Aruba subsets. the Kyoto and Aruba annotated data-sets have been chosen from the CASAS project, commonly used in Human Activity Recognition, in order to simulate a data-set which will have similar distributions to a UI log.

According to some embodiments of the present disclosure, the CASAS Aruba is a single occupancy dataset, where a volunteer woman interacts with 4 temperature sensors, 31 motion sensors, and 4 door closure sensors. This dataset contains 5 attributes, and 6438 activities were identified and tagged. Overall, the Aruba data-set contains 1,719,558 actions. The CASAS Daily Life Kyoto dataset represent sensor events collected in the WSU smart apartment dataset. The data represents 50 participants performing five activities in the apartment. The five tasks are: Make a phone call, Wash hands, Cook, Eat, Clean. Overall, the Kyoto dataset contains 6425 actions. Each sensor event is recorded by 1. Date 2. Time 3. SensorID 4. Value. Value can be a categorized or a continuous variable. These sensor events have been converted into a sequence resembling words by first sorting continuous sensor values into discrete bins, then assigning a unique token to each unique pair of (SensorID, (Discrete)-Value). Each dataset was assigned to a different number of bins.

According to some embodiments of the present disclosure, graph 610 shows the Pₖ and F-scores on the Kyoto dataset throughout the entire hyperparameter tunning procedure. Graph 620 shows the Pₖ score on the Aruba dataset throughout the entire hyperparameter tunning procedure. Graph 630 shows the performance of the model when using the Pₖ score and the F-score and using skip-gram Word2Vec and CBOW word2vec implementing both approaches the greedy approach and the DP approach on the Kyoto dataset. Graph 640 shows the performance of the model when using the Pₖ score and using skip-gram word2vec and CBOW word2vec implementing both approaches the greedy approach and the DP approach on the Aruba dataset.

FIG. 7A shows a comparison of results of computer-implemented method for unsupervised task segmentation to results of N-gram algorithm when using Aruba dataset, in accordance with some embodiments of the present disclosure.

According to some embodiments of the present disclosure, table 710 compares the results to a basic n-gram model, which breaks the sequence every time the probability of an n-gram drops below a given threshold. this is a sort of sanity check and a way of testing how hard the task at hand is. Multiple values for n have been tried and the probability threshold has been chosen as a percentile of probabilities of all n-grams on the current sequence. The threshold percentile was also tested across multiple values.

FIG. 7B shows a comparison of results of computer-implemented method for unsupervised task segmentation to results of N-gram algorithm when using Kyoto dataset, in accordance with some embodiments of the present disclosure.

According to some embodiments of the present disclosure, the best results can be seen in table 710 and table 720, the semantic segmentation algorithm, such as unsupervised topic-segmentation Natural Language Processing (NLP) module, achieves far better results than a naive n-gram on both the Aruba and the Kyoto datasets, both in scores of Pₖ and in F₁ score. Previous published work done on unsupervised segmentation of UI logs of Marcello et. Al. Identifying candidate routines for robotic process automation from unsegmented ui-logs, showed success in separating two routines from a dataset of hundreds of actions. During the experiments, the computer-implemented method for unsupervised task segmentation, such as computer-implemented method 200A for unsupervised task segmentation, in FIG. 2A which may operate an unsupervised task segmentation module, such as unsupervised task segmentation module 200B in FIG. 2B, showed success in separating 5-8 routines from a dataset of over a million actions, which is much closer to the real-world use case of this problem which makes it the best solution for the problem of segmentation for task mining.

FIG. 8 shows a graph 800 of comparison of results of computer-implemented method for unsupervised task segmentation to results to other solutions, in accordance with some embodiments of the present disclosure;

According to some embodiments of the present disclosure, the computer-implemented method for unsupervised task segmentation, such as computer-implemented method 200A for unsupervised task segmentation, in FIG. 2A which may operate an unsupervised task segmentation module, such as unsupervised task segmentation module 200B in FIG. 2B has been compared with the current and all additional implemented solutions in the Automation Finder for the segmentation problem. As can be seen from graph 800, the performance of the old legacy solution has been improved several times.

FIG. 9 shows a comparison of results of computer-implemented method for unsupervised task segmentation and previous solution, in accordance with some embodiments of the present disclosure. With a computer-implemented method for unsupervised task segmentation, such as computer-implemented method 200A for unsupervised task segmentation, in FIG. 2A which may operate an unsupervised task segmentation module, such as unsupervised task segmentation module 200B in FIG. 2B, routines with a higher score have been received, more occurrences and as a result a higher total time.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computer-implemented method for unsupervised task segmentation comprising:
receiving a stream of data of desktop-actions,
wherein each desktop-action relates to User Interface (UI) data-handling operations of applications, and
wherein each desktop-action is labeled with an action related integer identification (id);
operating an unsupervised task segmentation module on the stream of data of desktop-actions to identify one or more sequences of desktop-actions,
wherein each sequence of desktop-actions is identified as a sequence to achieve a task, and
wherein each task is a business process that is operated by a user and the business process is appropriate for automation,
said unsupervised task segmentation module comprising:
(i) creating an integer sequence from the action related integer id, such that desktop-actions in the stream of data are consecutively concatenated;
(ii) creating word embeddings of the UI data-handling operations of applications for each desktop-action based on the integer id thereof to yield a vector of embeddings; and
(iii) implementing unsupervised topic-segmentation Natural Language Processing (NLP) module on the created vector of embeddings to determine one or more cutting-points in the integer sequence to yield one or more segments such that semantic similarity level of embeddings in each yielded segment is maximized, and a number of non-complete business processes is reduced,
wherein each cutting-point of the one or more cutting-points in the integer sequence indicates an end of a first segment and a beginning of a second consecutive segment, and
wherein the one or more segments which represent complete tasks are provided to a routine mining module to identify repetitive segments for automation thereof.

2. The computer-implemented method of claim 1, wherein the similarity level of desktop-actions in each yielded segment is maximized by:
(i) defining a target function, wherein the target function is
$$J ( T ) := {\sum }_{i = 0}^{n - 1} ( ‖ {υ}_{i} ‖ - π ) .$$
whereby:
ui is a segment vector which is a sum of all vector embeddings in a segment [symbol] where w_i is a vector having one or more vector embeddings, and π is a penalty for each segment to avoid a segment of one word due to the maximizing.

3. The computer-implemented method of claim 1, wherein the UI data-handling operations of applications are collected from computer-devices of users by a Real-Time (RT) client that is running on each user computer-device and sends user desktop-actions to an RT server to be combined and exported to a database.

4. The computer-implemented method of claim 1, wherein the preprocessing of the data further comprises: removing UI data-handling operations that have been predetermined as insignificant.

5. The computer-implemented method of claim 1, wherein the unsupervised task segmentation module is pretrained to learn word embeddings, and wherein each word is a desktop-action related to UI data-handling operations of applications.

6. The computer-implemented method of claim 5, wherein the unsupervised task segmentation module is pretrained to learn word embeddings by a Word2Vec algorithm.

7. The computer-implemented method of claim 1, wherein the identified repetitive segments for automation are transformed into code, and wherein the code is a set of instructions and logic which is executed at runtime as a dynamic linked library interacting with one or more applications.
